(19) United States
(12) Patent Application Publication
(10) Pub. No.: US 2002/0016937 A1
(43) Pub. Date: Feb. 7, 2002

(54) Method and apparatus for utilizing a network processor as part of a test system

(76) Inventor: Henry Houh, Lexington, MA (US)

Correspondence Address: DALY, CROWLEY & MOFFORD, LLP, SUITE 101, 275 TURNPIKE STREET, CANTON, MA, 02021-2310, US

(21) Appl. No.: 09/920,259

(22) Filed: Aug. 1, 2001

Related U.S. Application Data
(60) Provisional application No. 60/222,384, filed on Aug. 2, 2000.
(60) Provisional application No. 60/248,269, filed on Nov. 14, 2000.

(51) Int. Cl. G06F 11/26

(52) U.S. Cl. 714/43

(57) ABSTRACT

The present invention utilizes a network processor as part of a test system for testing network environments and devices, and particularly VOIP networks and devices. The network processor is used as part of the test system and is precisely controlled by software to provide a variety of functions in order to test a network environment and devices. The test system incorporating the network processor may be programmed to process packets, create packets, receive packets and analyze packets. The test system thus provides simulation of network conditions using high bandwidth interfaces, a sniffing functionality with packet to flow correlation on high bandwidth interfaces, the capture and/or creation of network profiles, and the capture and analysis of network packets.

### CROSS REFERENCE TO RELATED APPLICATIONS

This application claims priority under 35 U.S.C. §119 (e) to provisional application serial No. 60/222,384 filed Aug. 2, 2000, and provisional application serial No, 60/248,269 filed Nov. 11, 2000, the disclosures of which are hereby incorporated by reference.

### BACKGROUND OF THE INVENTION

Voice over Internet Protocol (VOIP) is a fairly new technology that allows persons to send and receive voice, fax and data information over a combination of a phone network and a digital communications network. In traditional circuit switched networks such as a phone network, when a communication is established, a channel is dedicated end-to-end for the duration of the communication. Any unused bandwidth within the channel is unusable until the call is terminated. Research has shown that approximately sixty percent of a speech-based call is silence, thus a large portion of the bandwidth of a phone network is wasted. This is directly contrary to packet networks, wherein many types of communications share the bandwidth of the packet network. The capacity of the packet network is filled much more effectively in packet switched networks. Voice activity detection (VAD) technologies used in preparing voice signals for transporting across a packet network eliminate the silent space of a VOIP call in order to save more bandwidth, and speech compression technologies reduce the amount of data that must be transmitted when voice activity is present. By merging voice with the Internet or with an Intranet within an enterprise, the long distance telephone network and associated toll charges may be bypassed all together.

Due to the real time nature of voice transmissions, an effective voice conversation requires a reasonable level of continuity. Voice is a periodic or variable signal that includes inter-syllabic voices. A normal telephone call includes voice elements as well as non-voice elements such as conversational pauses. The continuity of a voice call can be affected negatively by a large number of packets competing with voice packets for network bandwidth. Traditional phone calls do not experience this problem, since they use a dedicated channel as described above. The equipment necessary for processing a voice communications for transport over a packet network must be able to retain and maintain the nuance, inflection and pauses that comprise effective voice communication in order to be acceptable.

In a VOIP environment voice signals are processed for transport over a packet network. The VOIP environment includes a pair of gateways at each end of the packet network. The gateways perform the compression and packetizing necessary to accomplish VOIP. Execution of the compression and packetizing processes by a gateway requires time. The processes introduce delay, also known as latency within the packet network. The network itself can also introduce delay, dependent upon how busy a router within the network path between the gateways is. The human ear can tolerate delay of approximately 250 milliseconds before perceiving a drop in continuity of a voice call. Delays longer than 250 milliseconds need to be avoided in order to maintain a good quality VOIP transmission.

Packet switched networks are typically bursty with lots of merging, exiting, and crossing traffic. Variable packet rates handled by the packet switches or routers lead to variable delay among packets going from one source location to a particular destination. This variable delay among packets is known as jitter. This jitter must be dealt with effectively in order to maintain the integrity of a VOIP transmission. In addition, routes from a source to a destination may change over time, causing more variable delay and possibly reordering of packets. Most gateways have buffers to collect packets and return acceptable continuity to the data to overcome some amount of jitter, however the use of the buffers to overcome jitter must be tuned to provide a minimal amount of delay.

The packet network itself may also be a contributor to problems with transporting voice over IP. The network may comprise various physical media, network protocols, as well as various routers and switches controlling the flow of traffic. Both the VOIP traffic and other non-VOIP traffic are competing for bandwidth on the same data network.

The protocols that define a data network were originally designed for non-real time traffic. In traditional digital packet networks, when a router or switch becomes overloaded with packets, the router or switch may drop packets in order to relieve the congestion. The end protocols have methods built into them to account for the dropped packets by routers and switches within the network such that data integrity is maintained, such as by requesting retransmission. While a certain amount of dropped packets are acceptable in a VOIP transmission, more than one to three percent of packet loss results in a poor quality VOIP transmission. Thus, it is important to monitor and test for dropped packets.

One prior attempt to test VOIP environments and devices comprises using a personal computer (PC) under software control to provide a low speed network emulation having statistical variation. This approach is limited to approximately tens of Mbit/second rates, which does not provide robust, real-time emulation of a VOIP environment, nor does this approach provide emulation of a particular user environment.

Traditional network switches or routers utilize general purpose processors or application specific integrated circuits (ASICS) having routing functions hard-coded into the ASIC. These devices are used to direct packets of data from an input port to an output port of the switch or router. A new class of integrated circuits known as network processors is just now becoming available. These network processors are intended to be utilized within network routers and switches. The custom developed ASICS and general-purpose processors can be replaced with commercially available network processors. The network processors are programmed to provide the desired routing routines for moving the packet data from an input port to an appropriate output. ASICS can take a year or more to develop, and if a need develops to modify the ASIC (e.g. to provide support for a new function), the modification can take six months or more as well as requiring removal of the old ASIC and replacement with the new ASIC. Network processors typically utilize a custom core and a special set of instructions to process communications function efficiently. Adding support for a new function simply requires modification of the software, and not modification or replacement of the network processor itself.

In view of the above it would be desirable to provide a test system which utilizes a network processor in order to provide emulation of a network, network packet sniffing, network packet capture and measurement, packet generation and termination, and to capture and/or provide network profiles. It would further be desirable for such a system to be easy to use and to have the ability to add new software tools.

### SUMMARY OF THE INVENTION

With the foregoing background in mind, it is an object of the present invention to utilize a network processor as part of a test system for testing network environments and devices, and particularly VOIP networks and devices. The network processor is used as part of the test system and is precisely controlled by software to provide a variety of functions in order to test a network environment and devices.

The test system incorporating the network processor may be programmed to process packets, create packets, receive packets and analyze packets. The test system thus provides simulation of network conditions using high bandwidth interfaces, a sniffing functionality with packet to flow correlation on high bandwidth interfaces, the capture and/or creation of network profiles, and the creation, capture and analysis of network packets.

The test system can be used as a network emulator. The network emulator injects network behavior between gateways of a VOIP network. The test system can add latency and jitter to the RTP (Real Time Transport Protocol) streams. The test system can also drop packets, duplicate packets and re-order packets within a stream. How and when these permutations are added to the RTP streams is determined by a network profile. Network profiles can be created by the user or captured by the packet capture and analysis tool.

The test system, when utilized as a VOIP packet capture and analysis tool, performs several functions. The packet capture and analysis tool can be used to analyze the RTP streams between two gateways. The network packet capture and analysis tool can be used to analyze the signaling protocol packet stream. The network packet capture and analysis tool can also be used to create profiles of network parameters, such as jitter and loss, over time for RTP streams and all other packets as possible. Additionally, the network packet capture and analysis tool can be used to filter and capture packets for post analysis. The packet capture and analysis tool can perform these functions across a number of physical ports.

Network profiles define a network's behavior over a period of time. In the case of VoIP streams there are several parameters that are important. The network profile defines how these parameters change over time. The parameters include packet latency, packet jitter (varying latency), packet re-ordering, packet loss—single or in bursts, and packet duplication—single packets. Profiles are applied to streams in two different ways. One way is relative to actual time. This means that packets received at the same time from two different RTP streams have the same network profile parameters applied to them. In the other way, profile parameters are applied to the packets of a stream relative to when the stream started. This means that two RTP streams have the same network profile parameters applied to their packets over the duration of the stream even if they were started at completely different times.

Network profiles can be created in several ways. A packet capture and analysis tool's capture buffer can be analyzed and a profile created from it. A user can create a specific profile from scratch using a GUI editing tool. A user can also create a profile from scratch by entering in statistical parameters, e.g. packet loss of two percent. When statistical parameters are used, a specific, deterministic profile is created. This allows repeatable runs of the networkemulator. Profiles can also be edited with a GUI. Segments of profiles can be cut and saved to disk. Profiles can thus be created by concatenating segments together.

The test system can be used to capture packets for later analysis. Most of the capture functionality is concerned with only capturing the packets of interest. When packets arrive at an interface port they are received and then filtered so that only those that meet certain criteria are eligible to be captured. Many times not all the data in a packet is of interest and therefore it is not necessary to store the whole packet. Data stripping takes care of removing unwanted data from the packet. A trigger function is used to turn On/Off the actual storing of the data from a filtered and stripped packet into the capture buffer. This enables the user to only capture packets around certain events. Once a set of packets has been captured, the user can view and analyze the captured packets in a post capture analysis step.

### BRIEF DESCRIPTION OF THE DRAWINGS

The invention will be better understood by reference to the following more detailed description and accompanying drawings in which:

FIG. 1 is a block diagram of a network processor used in the present invention

FIG. 2 is a block diagram of a prior art VOIP environment;

FIG. 3 is a block diagram of a test environment including the present invention;

FIG. 4 is a block diagram of a portion of a VOIP test environment;

FIG. 5 is a block diagram of a VOIP network packet capture and analysis tool environment;

FIG. 6 is a block diagram of a capture and analysis function of the present invention; and

FIG. 7 is a block diagram of a test environment including a network emulator and a network packet capture and analysis tool.

### DETAILED DESCRIPTION

Network processors such as the C-5 DCP available from C-Port Corporation of North Andover, Mass. are specifically designed for communications applications. The network processor is typically utilized to perform packet processing, cell processing, look-up table processing and queue management within a network switch or router. The present invention utilizes a network processor in a completely different manner by programming the various processors the network processor to provide test system functionality instead of switching and routing functionality.

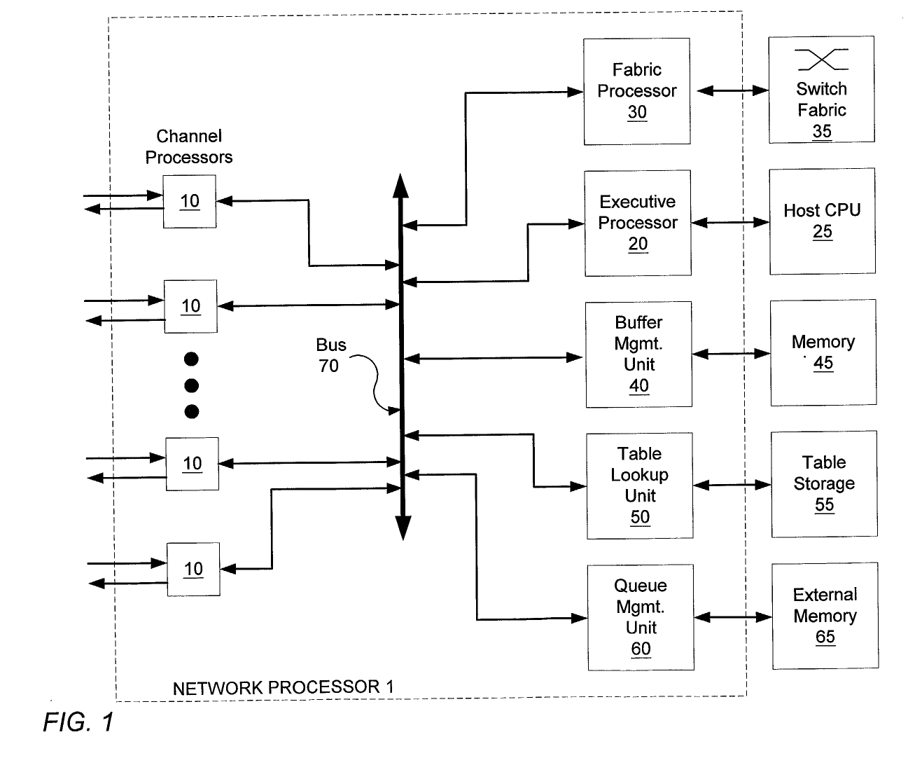

A block diagram of a network processor 1 is shown in FIG. 1. The network processor 1 incorporates dedicated RISC processors for each channel and for network specific tasks. Each processor is individually programmable to provide specific functions.

The network processor 1 includes sixteen channel processors 10 that are utilized for receiving, processing, and transmitting cells and/or packets. The network processor further includes five RISC processors for performing specific network tasks. The five processors comprise an executive processor 20, a fabric processor 30, a buffer management unit 40, a table lookup unit 50 and a queue management unit 60.

The network processor 1 includes a programmable channel processor 10 for each line interface. The channel processor 10 is used to handle cell and packet forwarding. Each channel processor 10 includes a two serial data processors and a RISC processor core which together form cell and packet processing. The serial data processors and RISC processor cores operate independently to perform specific tasks involved in the forwarding of a packet to a destination. The serial data processor provides programmable interfaces between external data streams and the channel processor elements. The channel processor core is used to build descriptors (cell/packet characterization), initiate further table lookups, collect table lookup results, classify cells/packets and perform scheduling based on the cell/packet characterization. Each channel processor supports a variety of interfaces. These interfaces include 10Mbit Ethernet, 100 Mbit Ethernet, 1 Gigabit Ethernet, 1.0625 Gbit FibreChannel, OC-3c, OC-12, OC-12c, OC-48c, T-1/E-1, and T-3/E-3. Other types of interfaces may also be supported.

The executive processor 20 is used to provide network control and management functions in user applications. The executive processor 20 manages the system resources of the network processor 1. The executive processor 20 is used to manage the network processor. The executive processor may also interface to an external CPU 25.

The fabric processor 30 is used to manage the interface to the switch fabric 35. The fabric processor 30 performs flow mapping and management to and from the switch fabric 35. The fabric processor 30 allows for scaling of network processing by connecting multiple network processors using external switch fabrics. The buffer management unit 40 is used to manage payload storage, and includes an interface which connects to external memory 45 which is used to store the payload data. The buffer management unit allows fast flexible memory management. The table lookup unit 50 is used for implementing complex table searches and updates. A memory interface is used to connect to external storage 55 that contains the circuit and forwarding tables.

The queue management unit 60 manages descriptor queues among the channel processors 10 and the executive processor 20. A memory interface is included for providing communication with an external memory 65 which stores payload descriptor queues.

The network processor 1 includes a bus 70. The bus 70 allows the different processors within the network processor 1 to be in communication with each other.

Having generally described a network processor, the application of a network processor to a test system will be described with respect to a particular type of network environment.

Voice Over IP (VOIP) is a method of using packet switched networks to carry data packets containing conversational voice fragments. Packet switched networks are cheaper to install and maintain than circuit switched networks traditionally used for voice calls, and many new voice carriers have used VoIP to provide long-distance voice connections at lower cost. Both these new and the old established carriers need to integrate their new VoIP systems with legacy circuit switching equipment. There are several pieces of equipment made specifically for this integration.

The first architectural component is the voice gateway or more simply, a gateway. A gateway is used to convert voice streams carried by conventional voice switching equipment into data packets. When the term gateway is used alone, it is implied that it is a voice gateway. The next component is the soft switch. The soft switch controls the call setup on the data side of the gateway. It also provides call control for advanced features. The final architectural component is the signaling gateway. The signaling gateway translates events in the voice switch domain (typically carried via SS7) and translates them into events in the data domain, which are understood by the soft switch.

The present invention comprises a test and measurement system incorporating a network processor. The system allows vendors of VoIP equipment to understand and hence improve their products to speed the acceptance and deployment of their products. The more general term Media over Packet (MoP) encompasses VoIP as well as other packetized data-switched applications such as streaming audio, streaming video, video conferencing and FAX over IP. The present application describes the invention focused on VoIP, but support for MoP is also intended by the present application.

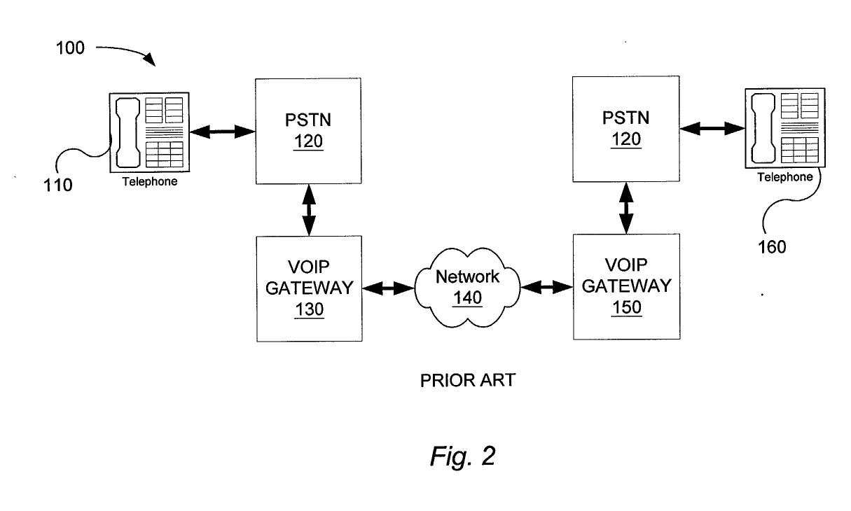

A prior art VOIP environment 100 is shown generally in FIG. 2. The environment comprises a first user device 110, a second user device 160, a phone network 120, a first gateway 130, a second gateway 150, and a packet network 140. A call originates from a first user device 110. In this embodiment the first user device is depicted as a telephone, though it should be understood that the telephone is only one possible device, and that user device 110 could also be a modem, a fax machine, or similar device. The output of the first user device 110 is transmitted along a phone network, such as a Public Switched Telephone network (PSTN) 120. The phone network may also be a private branch exchange (PBX), a private telephone network used within an enterprise.

The signal from the first user device 110 travels across the phone network 120 to a first gateway 130. A gateway is equipped with standard interfaces to the PSTN or PBX as well as interfaces to a packet network. The necessary encoding/decoding, compression/decompression, voice activity detection/comfort noise generation and packetizing/depacketizing are performed by the gateway. The processing of a voice signal into the format necessary for transport over a packet network is performed by the encoding/decoding subsystem within the gateway also known as a vocoder or alternatively as a codec. The first gateway may optionally decide to transmit a code indicating that there is no speech when it detects no speech.

The output of the first gateway comprises packetized data, suitable for transmission across a packet network 140. Packet network 140 may be the Internet, an Intranet or other packet type network.

A second gateway 150 receives the packet data on the packet network 140. The vocoder within gateway 150 depacketizes, decompresses and decodes the packet data into a voice signal. If the second gateway receives a code that signals that there is no speech present, it may choose create an appropriate level of comfort noise and feed the noise into the vocoder. The voice signal provided from second gateway 150 travels across a phone network 120 to a second user device 160. Second user device 160 is similar in function to first user device 110. Second user device 160 is also depicted as a telephone but could also be realized as a modem, fax machine, or similar user device. Preferably second user device 160 is the same type of device as first user device 110, such that a fax machine communicates with another fax machine for example.

Communications between the first and second user devices may be bi-directional; thus a similar set of processes happens between second user device 160 and first user device 110. Second user device 160 provides signals across the telephone network to second gateway 150. Second gateway 150 transforms the data from second user device 160 to packet data. This packet data is transported across the packet network to first gateway 130.

First gateway 130 receives the packet data from the packet network and transforms the packet data into voice data. The voice data is provided to first user device 110 over the telephone network 120. In such a manner unidirectional and/or bi-directional communications between first user device and second user device occurs.

The packet data traveling between the gateways 130 and 150 across packet network 140 may experience delay, jitter and packet loss. It is important, in order to provide a concise and accurate representation of the data, that the gateways 130 and 150 take into account and compensate for any delay, jitter and/or packet loss experienced by the data as it traverses the packet network between the gateways.

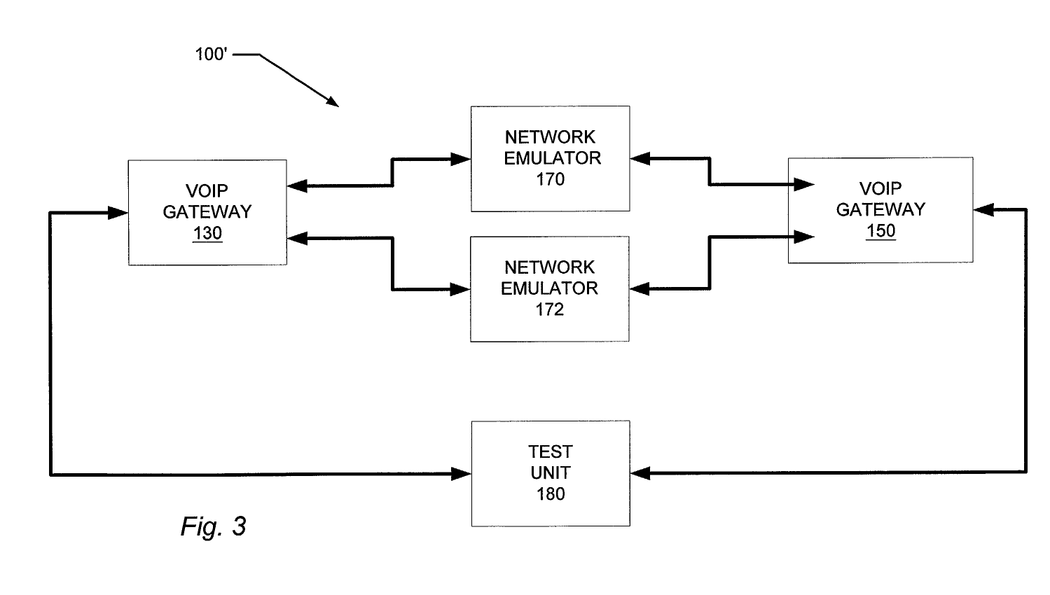

In order to test a VOIP environment and particularly devices within a VOIP environment a scenario 100′ shown in FIG. 3 is employed. A test unit 180 is used as part of the test environment. Test unit 180 provides voice data to gateways 130 and 150 and receives voice data from gateways 130 and 150. Gateways 130 and 150 convert the voice data to packet data and convert packet data to voice data. At least one test system 170 in which the network processor of the test system is programmed to provide test functionality such as performing as a network emulator is positioned between the first and second gateways on the packet network.

The network processor of network emulator 170 is programmable to receive a data stream at an input and to provide a modified data stream to an appropriate output. In order to properly test a VOIP environment and devices, the test environment must accurately reproduce a real world VOIP environment. In order to do so the processors within the network processor are programmed to receive packet data at one or more one input ports, and to provide an output packet data stream wherein the packets are provided at precise timing points with respect to the system time, such that the output packets stream includes packets having delay, jitter, packet loss, packet reordering and/or packet duplication. In such a manner the network processor is utilized to emulate a network by providing an output data stream representative of a real world VOIP environment

Test unit 180 provides a voice data stream to gateway 130. Gateway 130 converts the voice data stream to a packet data stream. The packet data stream from gateway 130 is provided to an input of network emulator 170. The network processor of network emulator 170, under program control, provides a modified packet stream to gateway 150. The modified packet stream may include packet delay, jitter, packet loss, duplicate packets and/or reordered packets. The modified packet stream is received by gateway 150 and converted to voice data. The voice data is then provided to test unit 180. Test unit 180 can then evaluate the received voice data to determine how effective gateway 150 was in accounting for delay, jitter, packet loss, reordered packets and duplicate packets provided by network emulator 170 while attempting to maintain an acceptable level of voice data.

Similarly, test unit 180 provides a voice data stream to gateway 150. Gateway 150 converts the voice data stream to a packet data stream. The packet data stream from gateway 150 is provided to an input of network emulator 172. The network processor of network emulator 172, under program control, provides a modified packet stream to gateway 130. The modified packet stream may include packet delay, jitter, packet loss, reordered packets, and duplicate packets. The modified packet stream is received by gateway 130 and converted to voice data. The voice data is then provided to test unit 180. Test unit 180 can then evaluate the received voice data to determine how effective gateway 130 was in accounting for delay, jitter, packet loss, reordered packets and duplicate packets while attempting to maintain an acceptable level of voice data.

As described above, the network emulators 170 and 172 inject network behavior between gateways 130 and 150. The network emulators add latency and jitter to the RTP streams. They can also drop packets, duplicate packets and re-order them. In addition to injecting network behavior, the emulators can also monitor the streams and replace the payload, i.e. audio data, in the streams. How and when these permutations are added to the RTP streams is determined by a network profile. Network profiles can be created by the user or captured by the packet capture and analysis tool.

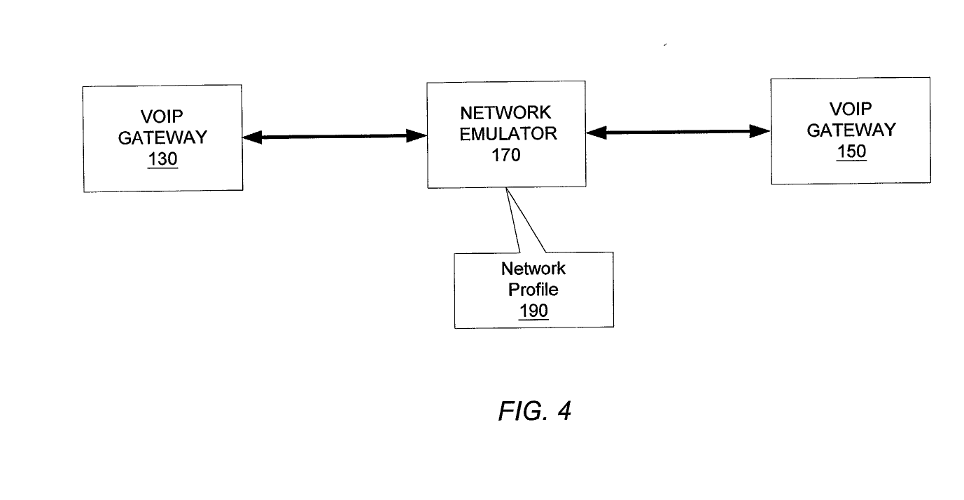

The user must configure the behavior of the network that the network emulator is trying to emulate. Network behavior for groups of RTP packets is defined. Groups are defined on the basis of source IP address and port and destination IP address and port. For instance all the RTP packets coming from IP address A and going to IP address B are given the same network behavior. Groups are also defined on the basis of other packet characteristics that can be grouped, such as all audio packets or all packets with the same differentiated services level. Network behavior is defined by several parameters that can change over time. These parameters include packet latency, packet jitter (varying latency), packet re-ordering (sudden, large, change in latency), packet loss, and packet duplication. Such an environment is shown generally in FIG. 4. A network profile 190 is presented to network emulator 170. The processors of the network processor within the network simulator are programmed to utilize the network profile to provide data at the appropriate times to gateway 130 and/or gateway 150 in accordance with the network profile.

The user assigns a network behavior, i.e. a set of parameter profiles, to each group. A profile defines how a parameter varies over time. These profiles have been previously created and stored away, or are created on the fly as needed. The profiles can come from a variety of sources such as actual profiles as measured by the packet capture and analysis tool on a real network, created by the user from a profiling application, and actual profiles that have been modified in the application.

Profiles are applied to streams in two different ways. One way is relative to actual time. This means that packets received at the same time from two different RTP streams have the same network profile parameters applied to them. In the other way, profile parameters are applied to the packets of a stream relative to when the stream started. This means that two RTP streams have the same network profile parameters applied to their packets over the duration of the stream even if they were started at completely different times.

A network profile can be applied on two levels: to the overall global time and referenced to the start of audio in a call. In the case of a global time profile, all the packets in different flows see the same profile. This is to emulate the overall behavior of a network. In the case where a network profile is applied referencing the start of a call, the network profile always starts at the very beginning of the audio stream. This feature is to allow the duplication of certain test situations in testing how various network profiles affect the audio quality in a deterministic manner.

Network profiles can be created in several ways. A packet capture and analysis tool's capture buffer can be analyzed and a profile created from it. A user can create a specific profile from scratch using a GUI editing tool. A user can also create a profile from scratch by entering in statistical parameters, e.g. packet loss of two percent. When statistical parameters are used, a specific, deterministic profile is created. This allows repeatable runs of the network simulator. Profiles can also be edited with a GUI. Segments of profiles can be cut and saved to disk. Profiles can thus be created by concatenating segments together.

In certain circumstances the user may want to replace the audio payload in the RTP streams with a pre-canned audio clip (or series of them) so that if he is using telephony load generators that do not generate actual audio on all channels, i.e. some channels are signaled only. This could be just to keep the audio codecs busy or to allow voice quality measurements across a large number of channels with different network behaviors. The audio stream could consist of a silence clip, followed by a tone clip (used as a signal to the test unit 180 to indicate that a Perceptual Speech Quality Measurement (PSQM) prompt is coming), followed by a PSQM clip. This is done on a group basis. The audio streams are pre-encoded using an application that converts audio files, like .wav files, into the various audio-encoding formats.

The user defines groups, IP address/Port pairs, gives each group a profile and defines whether the audio payload is being replaced. The profiles and replacement payloads are stored on disk. The group configurations are downloaded to the test system comprising the virtual system and then the system is started. Calls can then be generated between the gateways. While the system is running the user can monitor by way of the network emulator a number of parameters. These parameters include number of streams and streams per second, number of packets and packets per second, and number of bytes and bytes per second.

These parameters can be monitored on the basis of an interface, a group, or a single stream. The user can also look at a group or stream and see the profile it is running and where in the profile the parameters are being obtained.

The amount of delay, jitter, packet loss etc. provided by the network processor of the network emulator is programmable, thus characteristics of an existing VOIP environment can be measured and accurately emulated by the network emulator in the test environment to provide testing of how gateways 130 and 160 would respond if they were subject to the measured environment.

Accordingly, a user's existing VOIP environment can be measured and characterized and then the network processor within the network emulator can be programmed to provide a correspondingly similar output packet stream, thereby emulating the user's environment. Testing can be done to determine the response of the gateway(s) to the user's particular environment. For example, if a user's environment included packets experiencing lots of jitter, the network processor is programmed to provide an output packet stream also including similar amounts of jitter, thereby providing similar conditions to the gateway. The performance of the gateway can be measured in order to determine how well the gateway would perform in the user's particular environment.

Additionally, the network processor of the network emulator can be programmed to provide worst-case testing in order to ensure that a gateway will be able to provide acceptable results under worst case conditions. The network processor is programmed to provide maximum acceptable amounts of delay, jitter, packet loss, packet reordering and packet duplication and the gateway tested to determine how well the gateway handles the worst case packet stream provided by the network emulator.

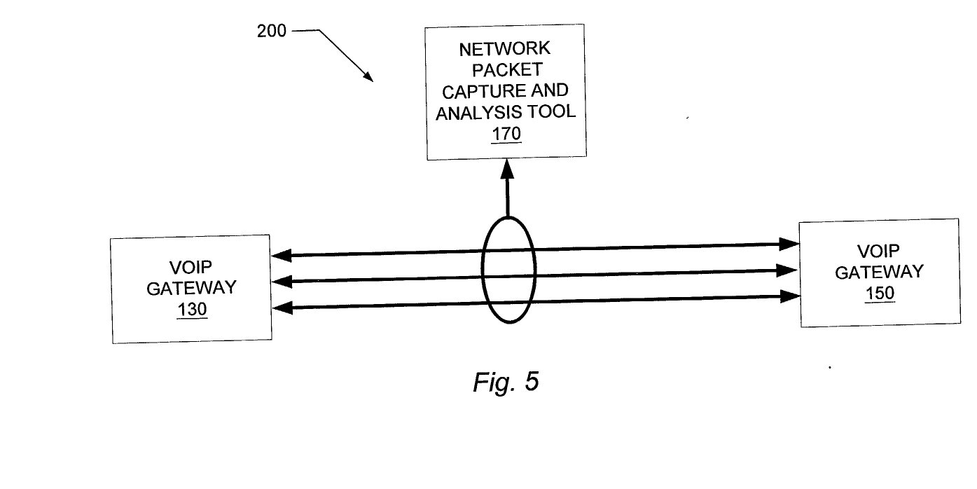

A further use of a test system incorporating a network processor is to program the processors within the network processor of the test system to direct the test system to function as a packet capture and analysis tool. An environment 200 including the test system programmed to function as a packet capture and analysis tool is shown in FIG. 5. The packet capture and analysis tool 170 passively analyzes the packets on a single port or pair of ports in a full-duplex system. The packet capture and analysis tool 170 analyzes the packets at a flow level and computes data that pertains to the overall flows. The packet capture and analysis tool 170 can monitor an interface port, a single RTP stream, or a group of RTP streams. An interface port can be monitored for such things as total packets, bytes per second and number of RTP streams present. A single RTP stream can be monitored for min/max/average jitter, packet loss, etc. The statistics for individual streams can be aggregated together for a group of streams. The control streams can be analyzed to provide high level statistics on control performance, such as call rate, call aborts, call setup to audio time, call establish time, call release time, and call duration.

The packet capture and analysis tool 170 can be used for purposes of monitoring. The audio statistics tracking functions independently of the control stream; i.e. the packet capture and analysis tool is able to automatically locate audio in a packet stream and begin tracking, without a priori knowledge of the call signaling. RTP streams are monitored for the following parameters: min/max/average packet jitter, number of packets lost, number of re-ordered packets, number of duplicated packets, number of packet errors, an audio encoding algorithm, packets per second and audio data per packet, and number of packets. These parameters are mapped to an overall voice quality score.

Groups of streams can also be monitored. An example of a group is all the RTP streams from a particular IP address, i.e. gateway. Group statistics are: include max/average packet jitter across all streams in the group, max/average number of packets lost across all the streams in the group, max/average number of packets re-ordered across all the streams in the group, max/average number of packets duplicated across all the streams in the group, max/average number of erred packets across all the streams in the group, breakdown of streams by audio encoding, max/average length of time, and average payload size.

The physical interfaces can be monitored for parameters such as max/average number of simultaneous active streams, current number of active streams, total number and rate of packets, total number and rate of bytes, max/average percent usage of the interface bandwidth, and total number and rate of errored packets.

A network profile can be created by using the packet capture and analysis tool functionality. A packet capture and analysis tool port is tapped into the network. The sniffing is set up to occur over a period of time and watch either a single stream or a group of streams. If watching a group of streams, such as all the streams from the gateway with a particular IP address, then the parameters are averaged together.

The test system is also useable for capturing network profiles. The packet capture and analysis tool can monitor a single or group of RTP streams to determine a network profile. As described earlier, a profile defines how a set of network parameters varies over time. The parameters include packet jitter, packet loss, packet re-ordering and packet duplication. The user can view profiles in a graphical format and segments of the profile can be stored on a hard disk. Stored profiles can be used by the network emulator to inject network behavior between two gateways. The user can create new profiles from scratch using a graphical UI, or by editing ones that had previously been stored.

The packet capture and analysis tool can analyze captured RTP packets in order to create a network profile. The profile can be viewed by the user in a GUI. All, or parts, of the profile can be saved for later use as a network simulation profile, or as a segment in a new profile. Previously saved profiles can be displayed in the GUI.

A set of plug-ins are available that can scan, and then flag, a network profile for particular events. For instance, there is a jitter plug-in that has a settable threshold for the maximum jitter. The user can set the jitter threshold and run the plug-in against a profile. Each place the jitter exceeds the threshold, the profile is marked. The user can then examine these areas of interest in the profile and potentially save some of them for inclusion in another profile. The list of plug-ins includes: packet to packet jitter threshold, dropped packets, and re-ordered packets.

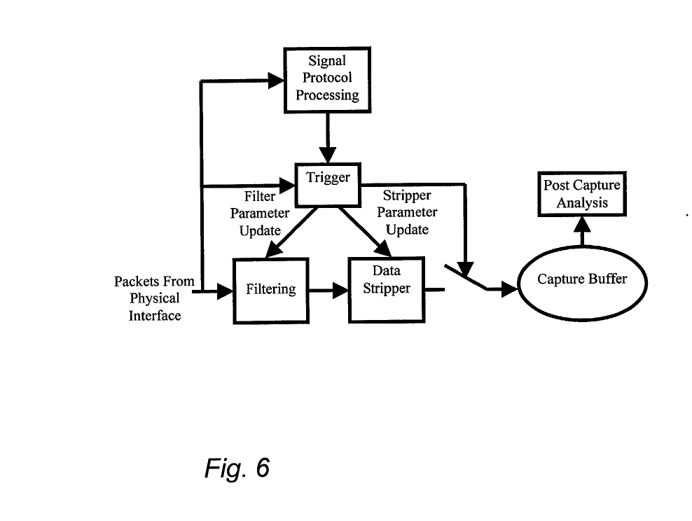

The processors within the network processor of the test system can be programmed to direct the test system to capture and analyze packets. As shown in FIG. 6, these packets can be any types that exist on the wire. Packets can be filtered prior to their being captured. This allows the user to take best advantage of the available buffer space. In addition to defining filters, the user can define triggers that can start or stop the capturing process. The buffer of captured packets can be post processed. The user can sort through the buffer using a post-viewing filter so that the user can view only the packets of interest. The user can also look at an individual packet in detail, viewing the raw bytes or in an annotated format that shows the values of selected fields.

Most of the capture process is concerned with only capturing the packets of interest. When packets arrive at an interface port they are received and then filtered so that only those that meet certain criteria are eligible to be captured. Many times not all the data in a packet is of interest and therefore it is not necessary to store the whole packet. Data stripping takes care of removing unwanted data from the packet. A trigger function is used to turn On/Off the actual storing of the data from a filtered and stripped packet into the capture buffer. This enables the user to only capture packets around certain events. Once a set of packets has been captured, the user can view and analyze them in a post capture analysis step.

The test system allows for packet filtering. Multiple filters can be used on the same port. The filtering process can allow all packets through, only RTP packets that meet a certain criteria, only signaling packets that meet a certain criteria, or any packets that meet some low-level criteria. The criteria for RTP packets is the same as for defining a group, namely source IP address, destination IP address, source UDP port number, destination UDP port number, interface port, and audio encoding algorithm. The criteria for signaling packets are source IP address, destination IP address, source UDP port number, and destination UDP port number. The criteria for low level filtering are MAC Address, MAC Ethernet type, IP Address, IP Protocol number, TCP/UDP Port, and specific byte mask pattern. High-level criteria can also be applied, such as a filter which examines packet contents and filters on the web page addresses requested.

Part of the packet capture process may include data stripping. The data stripping process removes data from a packet to reduce the capture buffer storage requirements. It allows the following components to be included/excluded from being stored: packet header—choose the protocol header to save; packet payload—relative to a particular protocol; and partial payload. In order to facilitate creating profiles the data stripper can cause the following information to be stored for a packet: a receive time stamp, an RTP time stamp and an RTP sequence number.

The test system also provides a triggering function. The trigger is used to freeze the capture buffer. The triggering event can be set to be at the 0%, 10%, 50%, 90% or 100% mark in the capture buffer. For instance, setting the mark to 50% means that half the packets in the buffer were before the trigger and half the packets came after the trigger. Trigger events include the following: a packet error, a start of a stream, an end of a stream, the same criteria as filters, jitter greater than a threshold, a dropped packet, a duplicate packet, a re-ordered packet, and a call signaling event.

Another feature of the test system is that groups of packet streams can be defined. Groups are used to gather statistics or add network characteristics to a set of related packets. For instance, RTP streams from a particular gateway can be grouped together. A user can then use a group to aggregate stream statistics about all the streams from the gateway, create a profile, or assign a network behavior to a set of streams. A packet's membership in a group is determined on the basis of source IP address, destination IP address, source UDP port number, destination UDP port number, interface port, and audio encoding algorithm.

IP addresses can be masked so that only some bits count toward determining whether a packet is in a group. The user can easily select a single IP address to match. Port numbers can be a range of ports or a single port. The user can easily select all ports or a single port. Any of the five parameters can be included or excluded from determining a packet's membership in a group.

Signaling events can also be the source of triggers. For instance, the signaling stream can be scanned for the start of a call and this in turn can cause a trigger. When a trigger event occurs, a number of things can happen. The capturing of packets can be started, stopped or stopped at a later time, depending on the percent mark set for the trigger. In addition, the parameters for the filter and data stripper can be changed. For instance, this could allow a user to capture the RTP headers at the beginning of a particular RTP stream. The following sequence of events would occur. First, the filter is set to allow all RTP packets through to the capture buffer. The stripper removes the payload from each packet so that only the RTP headers are stored. The trigger is set to the 25% mark. Next, the signaling stream is monitored for the beginning of a particular call. When the beginning of the call is detected the trigger event occurs. The trigger event causes the filter IP address and port pair parameters to change so that only the RTP packets for the call of interest are allowed through to the capture buffer. Signaling packets may optionally be allowed into the capture buffer. Capturing ends when 75% of the buffer is filled with the RTP packets for the call that came after the trigger and 25% of the buffer is filled with all the RTP packets that occurred before the trigger. The capture buffer is post processed so that the extraneous packets in the first 25% of the buffer are filtered out.

The test system can be used to provide post process analysis. The post processing analysis allows the user to look at the captured packets more closely. It provides several functions. One function is view filtering—only seeing the desired packets. Another function is data filtering—only seeing the desired data in the packets. An additional function is packet viewing—seeing the raw data in the packet. A further function is packet decoding—identifying fields and their values in a packet.

One of the features of the test system is the user view of the test system or group of test systems. The user can use all of the ports in a single test system, share a test system by only using some of the ports in a system, or use the ports from several test systems. Once the user has selected, and reserved, the ports the user is to use, the user operates the set of ports like they were in a single test system, essentially creating a virtual system. The test systems may be grouped to create a single large test unit administered by a single interface. Local time at each system must be synchronized with other systems at one millisecond or less. Test start/stop synchronization between the test systems must have one millisecond or finer resolution. This can be done without the need to connect the systems together physically. Test ports on a system can be partitioned to various users. Each test port can be assigned to a different user. Each user is able to independently configure, start and stop their own tests.

A particular scenario is shown in FIG. 3. The lab network has network emulators 170 and 172 on it in addition to other devices. The user has two gateways 130 and 150, each with twelve ports of 100 Mbit Ethernet. The user wants to setup and configure two of the network emulators twenty four ports to act as the network between the gateways.

The user begins by starting the network emulation application on a PC. This PC could be located anywhere on the corporate network, such as at the user's desk. The application locates the user name and machine name registered in the operating system, which is used when resources are being reserved so that reservations can be identified.

The user can then ask the application to identify all the network emulators on the network. The application automatically finds the network emulators and returns a list of them to the user. The user can query for information about each network emulator, e.g. name, IP address, location, configuration, software version, etc. The user selects from the list the network emulators the user wishes to use. For each test system the user can see what resources, e.g. interfaces, are already reserved and which are free. The user then selects which resources, interfaces, the user wants and reserves them. These resources become reserved by the user and any other user viewing those network emulators will see that the user's name as the reservee. At the time the user reserves the interfaces the user can enter a label and a note for the interface. For example, the test system B, port 1, might be labeled Ethernet 17, and have a note saying “Connected to Gateway A Ethernet port 9”. Once all the resources have been reserved the user has created a “virtual system” and from this point forward the user will interact with the virtual system as if it's a single network emulator over which the user has complete and sole control. The user can get his virtual system configuration and save it or print it out. The saved configuration could be loaded the next day to repeat the same test, and the printed configuration could be used to enable the user to cable up his test setup.

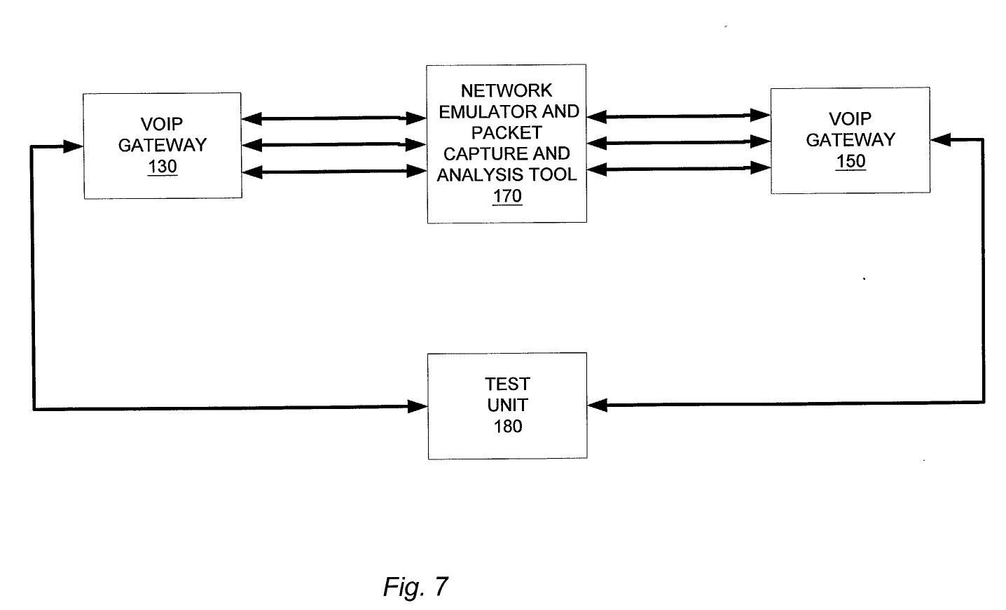

An additional scenario involving sniffing between two gateways while emulating the network is shown in FIG. 7. In this scenario the user wants to use the network emulation functions 170 to inject network behavior between the two gateways 130 and 180. In addition, the user wants to sniff the connections to the source gateway to verify that it is not introducing jitter and on the sinking gateway side to verify the network characteristics that the emulator is injecting into the path between the gateways.

In view of the above, the test system of the present invention utilizes a network processor, and programs the network processor to provide multiple test functions instead of the routing and switching functions the network processor is typically used for. The test system is thus able to function as a network emulator, to generate and playback network profiles, to act as a packet capture and analysis tool and to perform packet capture and analysis by programming the processors within the network processor. The test system can easily switch between functions merely by loading new software into the test system.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A test system for testing network environments and devices comprising:
a network processor;
storage associated with said network processor;
an interface coupling an output of said network processor to a communications network; and
instructions and data within said storage, said instructions and data directing said network processor to provide at least one function.

2. The test system of claim 1 wherein said at least one function is selected from the group consisting of a network emulator, a network profile generator, a network profile capture tool, a packet generation tool, an application traffic generation tool, a real-time packet analysis tool, and a network packet capture and analysis tool.

3. The test system of claim 1 wherein said test system is utilized with a variety of different protocols.

4. The test system of claim 3 wherein said protocols are selected from the group consisting of TCP, TCP/IP, MPLS, SCTP, UDP, and RTP.

5. The test system of claim 1 wherein said test system is utilized with a variety of different interfaces.

6. The test system of claim 5 wherein said interfaces are selected from the group consisting of 10Mbit Ethernet, 100Mbit Ethernet, 1 gigabit Ethernet, 1.0625 Gigabit Fibrechannel, OC-3c, OC-12, OC-12c, T1/E1, and T3/E3.

7. The test system of claim 1 further comprising at least one additional network processor.

8. The test system of claim 7 where at least one additional network processor is in communication with said network processor.

9. The test system of claim 1 further comprising a Central Processing Unit (CPU), said CPU in communication with said network processor.

10. The test system of claim 7 wherein said network processor is utilized as an accelerator to analyze data at line rates.

11. The test system of claim 9 wherein said network processor provides data to said CPU for analysis.

12. The test system of claim 9 wherein said CPU has a feedback loop to said network processor.

13. The test system of claim 1 wherein said test system changes from providing a first function to providing a second function by changing the instructions and data in said storage.

14. The test system of claim 1 wherein said test system provides additional functions simultaneously to the network processor by loading multiple sets of instructions in said storage.

15. A computer program product comprising a computer usable medium having computer readable code thereon, including program code comprising:
instructions for causing a network processor to provide at least one test function for testing network environments or devices.

16. The computer program product of claim 15 wherein said instructions for causing said network processor to provide at least one test function provide a function selected from the group consisting of a network emulator, a network profile generator, a network profile capture tool, a packet generation tool, an application traffic generation tool, a real-time packet analysis tool, and a network packet capture and analysis tool.

17. The computer program product of claim 15 further comprising instructions for causing said network processor to utilize a variety of different protocols.

18. The computer program product of claim 15 wherein said instructions for causing said network processor to utilize a variety of protocols comprise instructions for using a protocol selected from the group consisting of TCP, TCP/IP, MPLS, SCTP, UDP, and RTP.

19. The computer program product of claim 15 further comprising instructions for causing said network processor to utilize a variety of different network interfaces.

20. The computer program product of claim 15 wherein said instructions for causing said network processor to utilize a variety of different network interfaces comprises instructions for causing said network processor to utilize a network interface selected from the group consisting of 10Mbit Ethernet, 100Mbit Ethernet, 1 gigabit Ethernet, 1.0625 Gigabit Fibrechannel, OC-3c, OC-12, OC-12c, T1/E1, and T3/E3.

21. The computer program product of claim 15 further comprising instructions for causing at least one additional network processor to provide said at least one test function for testing network environments or devices.

22. The computer program product of claim 15 further comprising instructions for causing at least one CPU to communicate with said network processor.

23. The computer program product of claim 15 further comprising instructions for causing said network processor to be utilized as an accelerator to analyze data at line rates.

24. The computer program product of claim 22 further comprising instructions for causing said network processor to provide data to said CPU for analysis.

25. The computer program product of claim 22 further comprising instructions for causing said CPU to operate in a feedback loop with said network processor.

26. A method of testing network environments and devices comprising:
providing a network processor;
coupling said network processor to a communications network; and
directing said network processor to provide at least one function.

27. The method claim 26 wherein said step of directing comprises directing said network processor to provide at least one function selected from the group consisting of a network emulator, a network profile generator, a network profile capture tool, a packet generation tool, an application traffic generation tool, a real-time packet analysis tool, and a network packet capture and analysis tool.

28. The method claim 26 further comprising the step of utilizing a variety of different protocols.

29. The method of claim 26 wherein said step of utilizing comprises utilizing a protocol selected from the group consisting of TCP, TCP/IP, MPLS, SCTP, UDP, and RTP.

30. The method claim 26 wherein said step of coupling is performed with a variety of different interfaces.

31. The method claim 30 wherein said interfaces are selected from the group consisting of 10Mbit Ethernet, 100Mbit Ethernet, 1 gigabit Ethernet, 1.0625 Gigabit Fibrechannel, OC-3c, OC-12, OC-12c, T1/E1, and T3/E3.

32. The method claim 26 further comprising the step of providing at least one additional network processor.

33. The method claim 32 where at least one additional network processor is in communication with said network processor.

34. The method claim 26 further comprising the step of providing a Central Processing Unit (CPU), said CPU in communication with said network processor.

35. The method claim 32 further comprising the step of using said network processor as an accelerator to analyze data at line rates.

36. The method of claim 34 further comprising the step of using said network processor to provide data to said CPU for analysis.

37. The method of claim 34 further comprising the step of providing a feedback loop between said network processor and said CPU.

38. The method of claim 26 further comprising the step of changing from directing said network processor to provide a first function to directing said network processor to provide a second function.

39. The method of claim 26 further comprising the step of directing said network processor to provide more than one function simultaneously on the same said network processor.
